(19) United States
(12) Patent Application Publication
(10) Pub. No.: US 2006/0289651 A1
(43) Pub. Date: Dec. 28, 2006

(54) System for improved optical mark recognition

(76) Inventor: Steve Gostling, Raleigh, NC (US)

Correspondence Address: CARSTENS & CAHOON, LLP, P O BOX 802334, DALLAS, TX, 75380, US

(21) Appl. No.: 11/158,854

(22) Filed: Jun. 22, 2005

(51) Int. Cl. G06K 7/10

(52) U.S. Cl. 235/454

(57) ABSTRACT

An improved optical mark recognition system is disclosed. A pre-printed form including sets of answer choices to be scored is selected. A pristine copy of said form is obtained. Reference marks for said form are defined. Reference areas surrounding said reference marks, for locating reference marks on scanned copies of said form in the future, are defined. The location of answer choices on said form is defined. Subsequently, answer choices on a copy of said form are marked during the course of testing, collection of demographic information, collection of data, and so forth. If pages of said form are collected in a booklet, said pages are separated from the booklet prior to scanning by slitting said pages from the booklet spine. A marked copy of the form is scanned. Reference marks on the marked copy of the form are located through a method of directional-finding. The location of reference marks on the scanned form enables accurate scoring of answer choices whose relative location on the form has been altered from improper slitting of booklets, or from stretching or shrinking of a form resulting from changes in humidity, etc. An answer choice is scored by first establishing a configurable search area slightly larger than the answer circle. The system computes a raw intensity for each pixel within the answer circle. The total intensity for the search area is determined by adding together the intensity for each pixel. The total intensity is adjusted using an appropriate calibration factor. The system accounts for whether scanned image of marked form is filtered. The total intensity for search area is divided by a value, such as 17. This adjusted measurement for intensity is divided into the original, unadjusted measurement for the total intensity of the search area. Finally, the lowest intensity level is discarded to reduce the influence of random background noise. This scoring operation is repeated on other answer choices, as necessary.

### BACKGROUND OF THE INVENTION

1. Technical Field

The present invention relates to an improved optical mark recognition system. Specifically, the invention relates to a system and method for scoring answer choices marked on pre-printed forms.

2. Description of Related Art

Optical mark recognition is a method of computerized input, ordinarily from paper forms. One of the most familiar applications of optical mark recognition is the #2 pencil bubble test. Students mark their answers, or other information, by darkening circles marked on a pre-printed sheet. Afterwards, the sheet is automatically graded by a scanning machine. In addition to testing, optical mark recognition may be used in reading survey questionnaires, collecting census data, conducting market research, inventory control, and in many other fields. Generally, a user makes marks in specific regions of a pre-printed form for the purpose of designating answers to various queries. The form containing the user's marks is then later “read” or “scored” via some sort of computer-assisted process that determines which responses the user has designated. Said responses are then organized for reporting of the results. Optical mark recognition applications often require the processing of marked responses on hundreds or even thousands of pre-printed forms. For this reason, it is imperative that the process of reading the marks be as reliable and quick as possible.

The present invention is an improved optical mark recognition system.

### SUMMARY OF THE INVENTION

An improved optical mark recognition system is disclosed. A pre-printed form including sets of answer choices to be scored is selected. A pristine copy of said form is obtained. Reference marks for said form are defined. Reference areas surrounding said reference marks, for in the future locating reference marks on scanned copies of said form, are defined. The location of answer choices on said form is defined. Subsequently, answer choices on a copy of said pre-printed form are marked during the course of testing, collection of demographic information, collection of data, and so forth. If pages of said form are collected in a booklet, said pages are separated from the booklet prior to scanning by slitting said pages from the booklet spine. A marked copy of the form is scanned. Reference marks on the marked copy of the form are located through a method of directional-finding. The location of reference marks on the scanned form enables accurate scoring of answer choices whose relative location on the form has been altered from improper slitting of booklets, or from stretching or shrinking of a form resulting from changes in humidity, etc. An answer choice is scored by first establishing a configurable search area slightly larger than the answer circle. The system computes a raw intensity for each pixel within the answer circle. The total intensity for the search area is determined by adding together the intensity for each pixel. The total intensity is adjusted using an appropriate calibration factor. The system accounts for whether the scanned image of a marked form is filtered. The total intensity for the search area is divided by a value, such as 17. This adjusted measurement for intensity is divided into the original, unadjusted measurement for the total intensity of search area. Finally, the lowest intensity level is discarded to reduce the influence of random background noise. This scoring operation is repeated on other answer choices, as necessary.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts an exemplary form that could be scored using the system of the present invention.

FIG. 2 depicts an exemplary form that could be scored using the system of the present invention.

FIG. 3 depicts an exemplary form that could be scored using the system of the present invention.

FIG. 4 depicts the form of FIG. 1, but including defined reference areas and sets of answer choices.

FIG. 5 depicts the form of FIG. 2, but including defined reference areas and sets of answer choices.

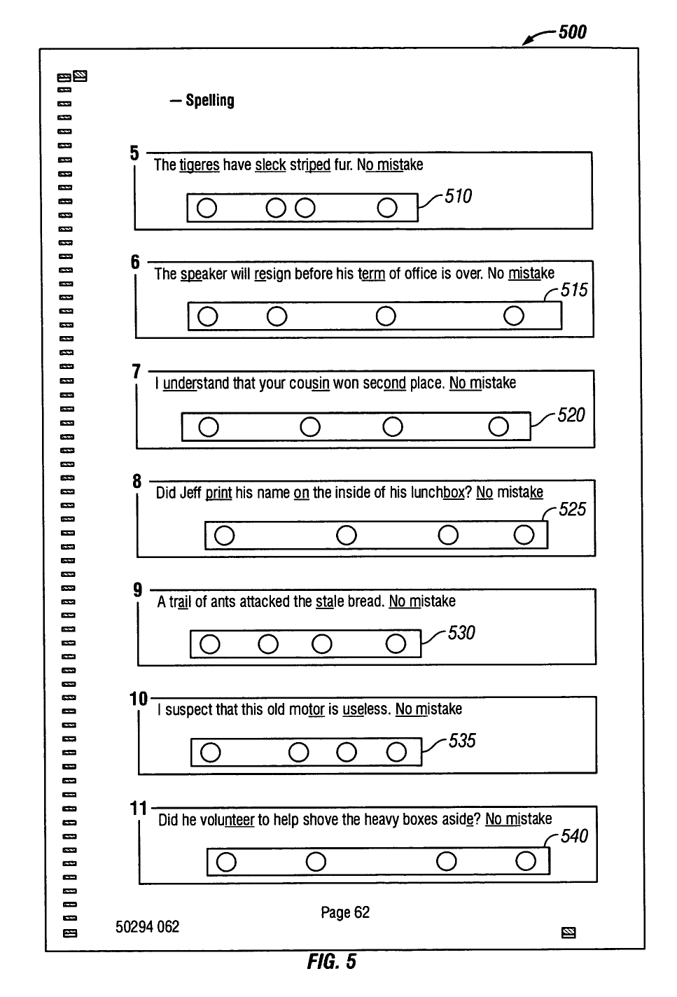

FIG. 6 depicts the form of FIG. 3, but including defined reference areas and sets of answer choices.

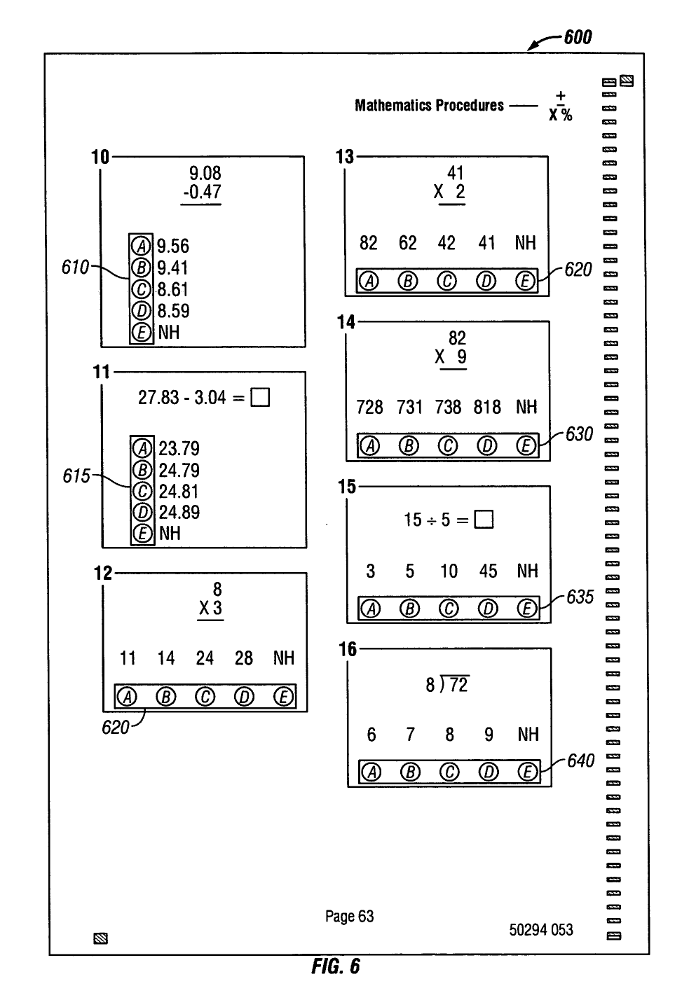

FIG. 7 is a logical flowchart diagram illustrating a method for scoring answer choices in accordance with an exemplary embodiment of the present invention.

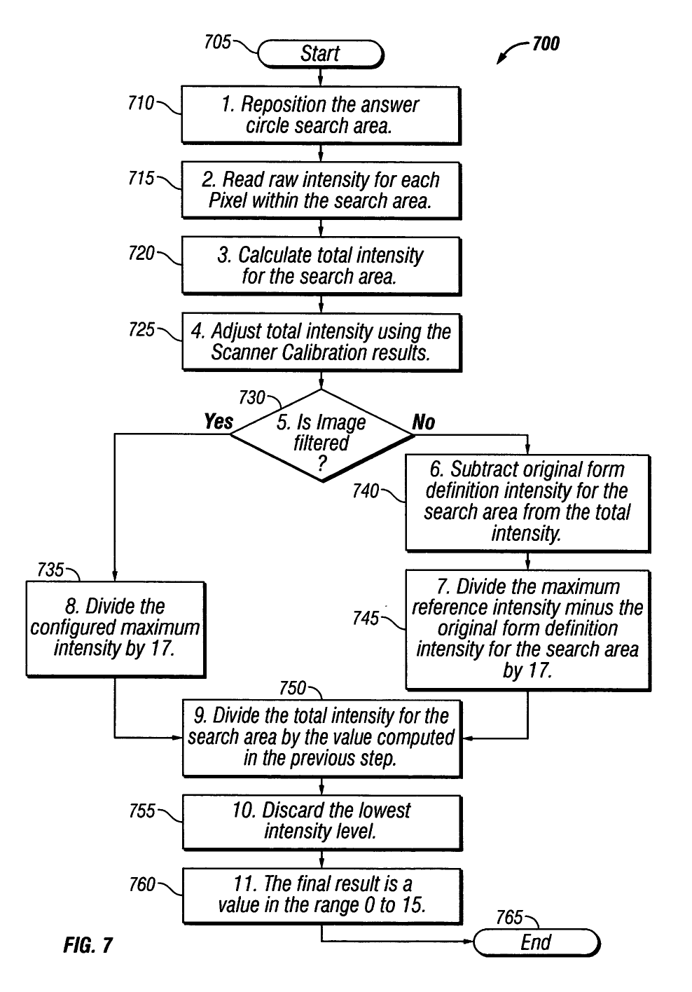

### DETAILED DESCRIPTION OF THE INVENTION

Selecting the Form

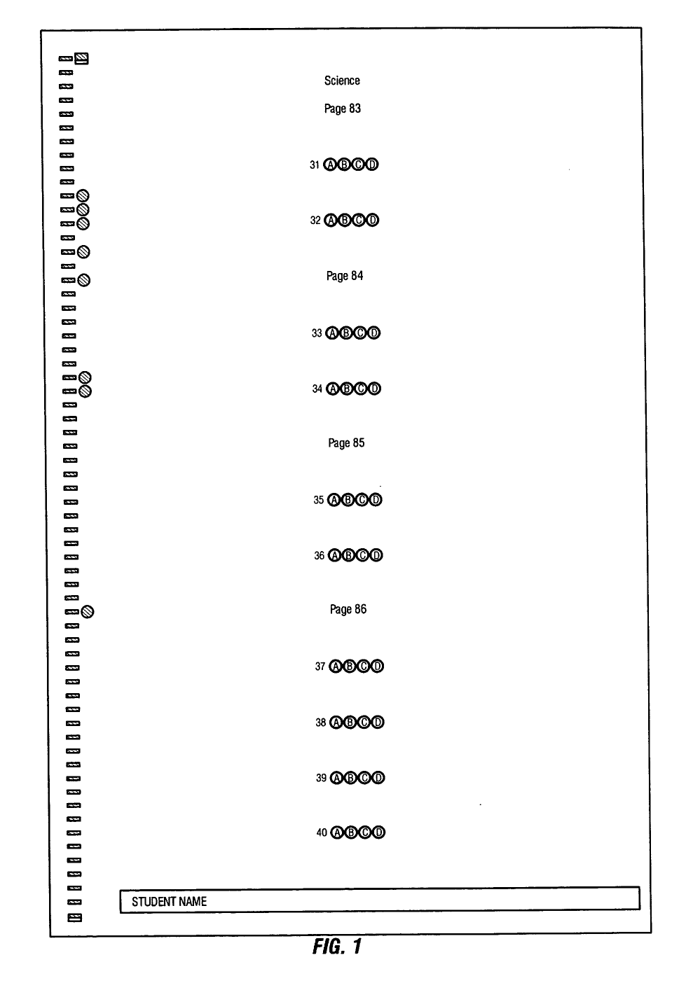

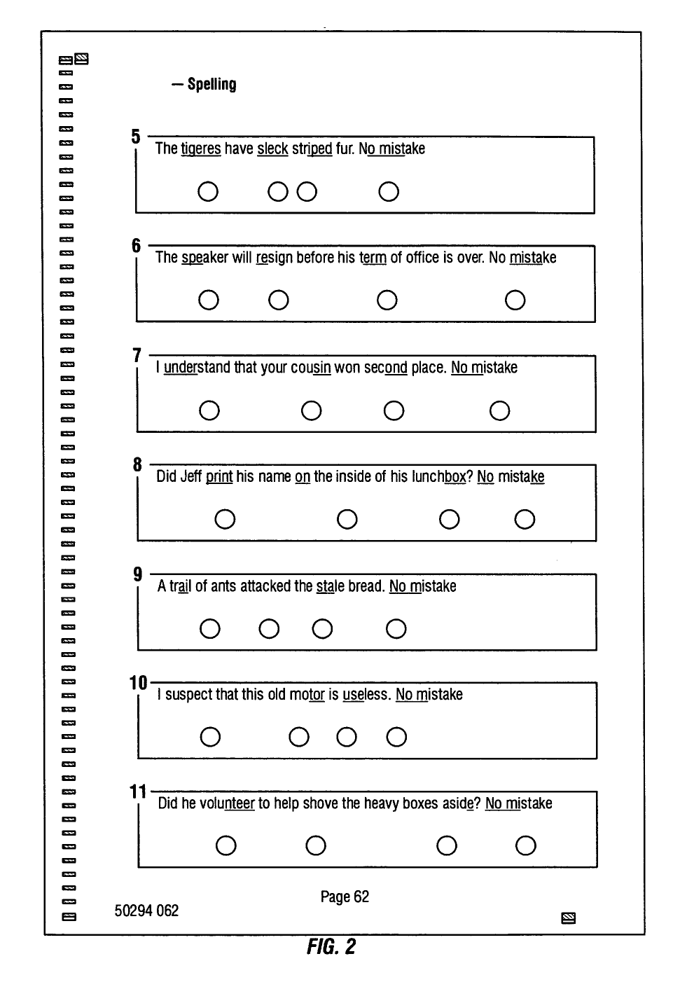

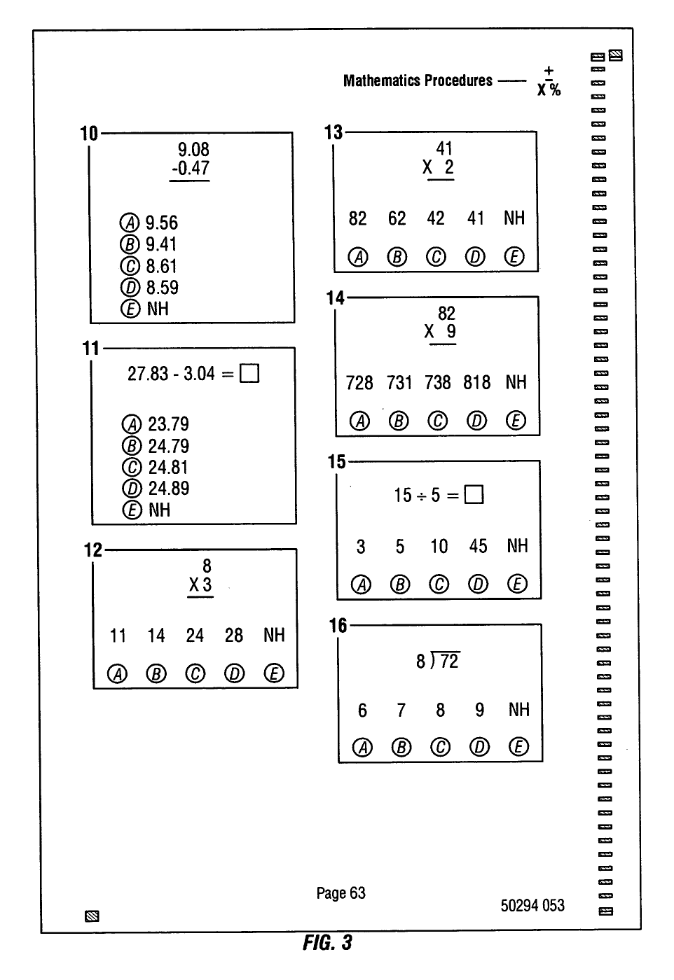

The first step in implementing the present invention is selecting a pre-printed form to be processed. Each form may include more than one page. Typically, the form to be processed includes sets of answer choices, as in the example depicted in FIG. 1. Sometimes, a form includes written questions or problems accompanying the sets of answer choices, as in the examples depicted in FIG. 2 and FIG. 3. In these cases, the forms are “scored” to analyze the answers chosen by the individuals that fill-out the forms. Forms having sets of answer choices relating to questions and/or problems may also include portions having sets of answer choices relating to demographic information of the individual filling-out the form. Indeed, the present invention is not limited to the scoring of correct answers. It also may be used in various industries, including but not limited to financial services, higher education, healthcare, hospitality and government, to collect demographic information, or any other kind of data. Note that the “scoring” of a form includes the process of analyzing any set of answer choices, whether said answer choices relate to test questions and/or problems, or the collection of demographic information or other data.

Defining the Form

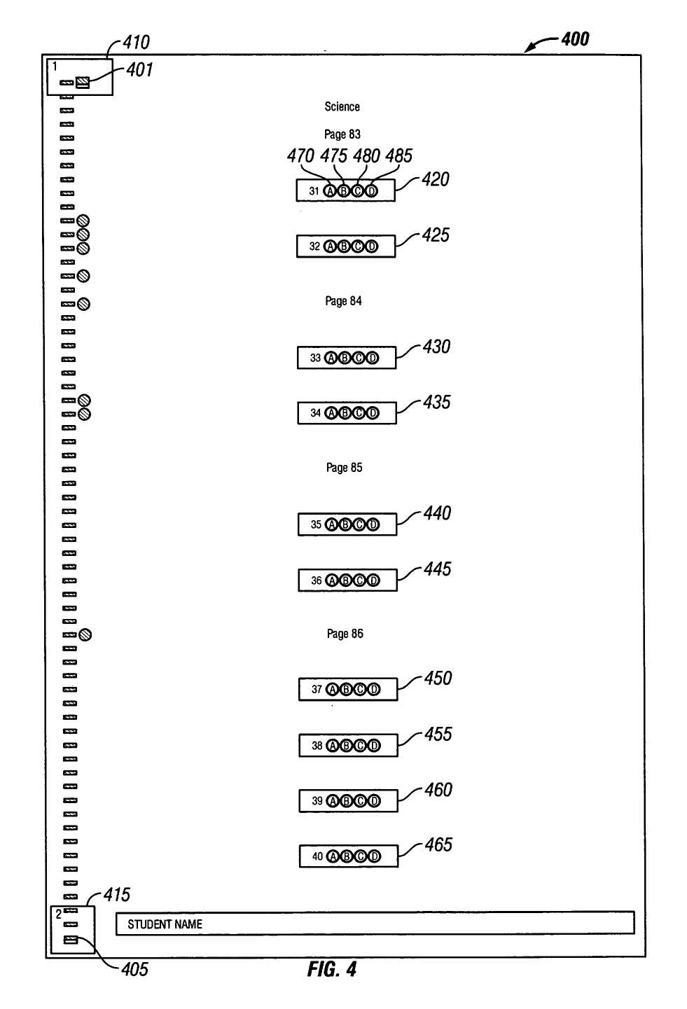

After choosing a pre-printed form to be scored, a pristine version of the chosen form is obtained. Then, at least three discrete portions of each form must be defined: (a) reference marks; (b) reference areas; and (c) answer choices. The following description of the process of defining a form is made with reference to FIG. 4.

Reference marks 401 and 405 and are established on form 400. As explained in more detail below, said reference marks are used to align the form. Though reference marks may vary by location, size, type, and number of pixels, like reference marks 401 and 405, they typically are located in the comers of each page of a form, rectangularly-shaped, and colored black. More than one reference mark must be established on each page of the form. In a preferred embodiment, there are two reference marks established on the left-side of each page of the form—one reference mark 401 is located in the top left-hand corner of each page of the form and the other reference mark 405 is located in the bottom left-hand corner.

Reference areas 410 and 415 also must be established for the form. Reference areas 410 and 415 are general areas within which reference marks 401 and 405, respectively, should be found. Typically, there are as many reference areas as there are reference marks, i.e., one reference area for each reference mark. In a preferred embodiment, two reference areas are established for each page of the form-reference area 410 in the top left-hand corner of each page of the form and another reference area 415 in the bottom left-hand corner of the form. A reference area must be larger than the area encompassed by its concomitant reference mark. Indeed, it should be large enough such that the reference mark is within the reference area even when it has been skewed from off-alignment slitting of forms (described in greater detail below), stretching or shrinking of forms from changes in humidity, etc.

Finally, answer choice sets 420, 425, 430, 435, 440, 445, 450, 455, 460 and 465 must be defined on the form. Defining said answer choice sets requires identification of the number of sets of answer choices on the form. In the case of FIG. 4, there are ten answer choice sets. It also requires identification of the location of each set of answer choices on the form and the location of each answer choice within each set. Thus, a user would define the location of answer choice set 420, and answer choices 470, 475, 480 and 485. In the case of answer choice sets relating to test questions/problems, the correct answer choice for each such set may also be established at the time a form is defined. Alternatively, the correct answer choice may be designated at a later time.

Different forms may have differently-located and -sized sets of answer choices. A form 500 used for testing of spelling skills might require the defining of answer choice sets 510, 515, 520, 525, 530, 535 and 540. A form 600 for testing of mathematics procedures might require the defining of answer choice sets 610, 615, 620, 625, 630, 635 and 640.

As noted above, each form may consist of more than one page. Indeed, a form may consist of many pages. In the event that a form does consist of more than one page, the above-described defining process must be performed with respect to each page of the form.

Slitting the Form

Often, the form to be scored consists of multiple pages collated into a booklet. To facilitate scanning and scoring of such forms, said pages should be separated from one another. The preferred method of separating pages of a form contained in a booklet is by slitting said pages from the booklet at the booklet binding.

Scanning

Next, the form is scanned. Since slitting of a form booklet consisting of multiple pages can be imprecise, there often is a discrepancy between the width of the scanned form and the width of the originally defined form. For this reason, the width of each page of the form is determined at the time it is scanned. If the width of a scanned page is different from the width of the associated page of the defined form, then it was not cut properly from its booklet binding. Ascertaining the width of each page of the form at the time the form is scanned makes possible accounting for the differing location of reference marks and answer choices resulting from imprecise slitting of form booklets.

Directional Finding of Reference Marks

The next step in scoring a form involves the directional finding of reference marks. By directional finding, it is meant that the system looks for a black mark within a specified reference area of an image of a page of the scanned form. As stated earlier, reference areas should be sufficiently large to allow for off-alignment slitting of forms from booklet bindings and stretching or shrinking of the pages of a form resulting from changes in humidity, and the like.

After applying a reference area to the scanned image, said area is processed directionally, e.g., left to right, bottom to top, corner to corner, and so forth. While processing said area directionally, the system is looking for the reference mark. For example, in the case of reference area 410, the reference mark is the square-like object 401 rather than small dash 403 to the left of the square-like object. In one embodiment, the system would be directed to look within reference area 410 directionally from left to right for reference mark 401. The system looks for the first mark found directionally in the reference area from left to right. As soon as a mark is encountered, the system determines the width and height of said mark and a pixel count for said mark. The system then compares identifying characteristics of the encountered mark, such as height and width, or pixel count, with the affiliated data for the defined reference mark, in this case reference mark 401. Assuming the data for the encountered mark exceeds a given confidence level, e.g., the mark has 90% of the number of pixels in reference mark 401, the system assumes it has found the first reference mark 401. If the first encountered mark does not fit the criteria for reference mark 401, the system continues processing the reference area from left to right until another mark is encountered, and the same process of comparing the height, width and/or pixel count of the encountered mark with reference mark 401 is performed, until the system detects a match. As soon as such a match occurs, the system moves on to the next reference area to locate the next reference mark. In the case of the form depicted in FIG. 4, the next reference mark to be located is reference mark 405.

After all reference marks are located, the system then determines the horizontal and/or vertical movement, horizontal and/or vertical stretch, and rotation for each page of the scanned form. With this information, the system is able to determine where on each page of the form each question and set of answers is located on the form. For instance, knowing how much the document has stretched due to, for instance, humidity, the system may know that the answer choices for a particular question are located 0.07 inches to the left and 0.05 inches above where those same choices are located on the defined form.

Scoring

Finally, the process of scoring marked answers begins. A logical flowchart diagram is presented to illustrate the general tasks conducted by the system when analyzing how well a particular answer circle was marked. A method 700 begins at START step 705 and proceeds to step 710, in which the system locates the first set of answer circles to be scored. The system recalls the originally defined location of an answer circle from the form definition. Then, applying the already calculated data on movement, stretching, and rotation of the form, the system establishes a configurable search area for said answer circle, which is an area slightly larger than the physical diameter of the answer circle itself. An advantage to taking a larger circle is that it allows for the scoring of marks made slightly outside lines of the defined circle.

Then, in step 715, the system computes the raw intensity of pixels within the configurable search areas for said answer circle. Preferably, said intensity is computed by determining the raw intensity for each pixel within the search area on a scale of 0 to 255 for an 8 bit image.

In step 720, the total intensity for the search area is determined by adding together the intensity for each pixel in the search area. Using a configurable mark parameter for importance of area versus darkness, the maximum value for each pixel may be limited. For example, although the intensity of a pixel might be 240, if the mark parameter cap is 128, then only 128 will be added by that pixel to the total intensity value for the search area.

Next, in step 725, the total intensity of the search area is adjusted using the appropriate calibration factor. Using the closest medium darkness bubble on the calibration sheet, a calibration factor for the current answer circle is computed using the central calibration sheet and the latest calibration sheet for the scanner where the current image was scanned. The calibration factor is applied to the total intensity for the search area. This may increase or decrease its value.

In step 730, the system considers whether the scanned image of the form has been filtered. A filtered image is one that has been scanned using optical color filters to remove the original print. The resulting image will only contain the actual marks made by the student.

In the event that the scanned image has been filtered, the “YES” branch is followed to step 735 and the total intensity for the search area is divided by 17.

If the scanned image has not been filtered, the “NO” branch is followed to step 740 and, since these answer circles may contain character and/or background shading, the original intensity of the printed circle is subtracted from the earlier-calculated total intensity of the search area. Then, in step 745, the adjusted total intensity for the search area is divided by 17.

In step 750, the total intensity for the search area computed in step 720 is divided by either the number derived in step 735, if the image was filtered, or step 745, if the image was not filtered. In either case, the resulting value is a number between 0 and 16.

In step 755, the lowest intensity level is discarded to reduce the influence of random background noise on the image from an answer. This operation, in step 760, causes the final value of the intensity level to be a number in the range 0 to 15.

The process 700 is terminated at the END step 765.

Preferably, the system is configured to analyze the marking of each answer choice in every set of answer choices. For instance, in the case of answer choice set 420, process 700 is preferably applied with respect to each answer choice 470, 475, 480 and 485. This enables the system to track the first, second, third and fourth darkest marks so that it can also track whether any individuals using form 400 originally had the correct answer and changed to an incorrect answer, and how often they did it. This might help determine more easily and quickly whether there were any bad questions.

Conclusion

The description of the present invention has been presented for purposes of illustration and description, but is not to be assumed to be exhaustive, nor is the invention intended to be limited to the form disclosed. Many modifications and variations will be apparent to those of ordinary skill in the art. The embodiment was chosen and described in order to best explain the principles of the invention to enable others of ordinary skill in the art to understand the invention for various embodiments with various modifications as are suited to the particular use contemplated.

I claim:

1. A method of scoring marks on a preprinted form, comprising the steps of:
(a) scanning a marked, preprinted form;
(b) establishing a configurable search area for a preprinted answer circle on said form;
(c) computing the raw intensity of each pixel within said search area;
(d) calculating an unadjusted total intensity for said search area; and
(e) calculating an adjusted total intensity by dividing said unadjusted total intensity by a factor.

2. A method according to claim 1 wherein said configurable search area is an area slightly larger than the physical diameter of the answer circle.

3. A method according to claim 2 wherein the original intensity of the preprinted answer circle is removed from said calculated unadjusted total intensity if the scanned image is not filtered.

4. A method according to claim 3 wherein the lowest intensity level is discarded after calculating said adjusted total intensity.

5. A method according to claim 4 wherein the movement, stretching, and rotation of said scanned form are taken into account when determining the location of said answer circle.

6. A method according to claim 4 wherein the unadjusted total intensity is divided by a factor of less than 100.

7. A method according to claim 4 wherein the raw intensity of each pixel within said configurable search area is computed within a range of 0 to less than 1000.

8. A method according to claim 4 wherein the raw intensity of each pixel within said configurable search area is computed using all bits of the image.

9. A method according to claim 4 wherein the raw intensity of each pixel within said configurable search area is computed within a range of 0 to 255 for an 8 bit image.

10. A method according to claim 5 wherein the unadjusted total intensity is divided by a factor of less than 100.

11. A method according to claim 5 wherein the raw intensity of each pixel within said search area is computed within a range of 0 to less than 1000.

12. A method according to claim 5 wherein the raw intensity of each pixel within said configurable search area is computed using all bits of the image.

13. A method according to claim 5 wherein the raw intensity of each pixel within said configurable search area is computed within a range of 0 to 255 for an 8 bit image.

14. An apparatus for scoring marks on a preprinted form according to the method of claim 1, comprising:
(a) a computer configurable to access a marked, preprinted form, wherein said computer contains instructions programming said computer to perform said method.

15. An apparatus according to claim 14 wherein said computer contains instructions programming said computer to make said configurable search area an area slightly larger than the physical diameter of the answer circle.

16. An apparatus according to claim 15 wherein said computer contains instructions programming said computer to remove the original intensity of the preprinted answer circle from said calculated unadjusted total intensity if the scanned image is not filtered.

17. An apparatus according to claim 16 wherein said computer contains instructions programming said computer to discard the lowest intensity level after calculating said adjusted total intensity.

18. An apparatus according to claim 17 wherein said computer contains instructions programming said computer to account for the movement, stretching, and rotation of scanned form when determining the location of said answer circle.

19. An apparatus according to claim 17 wherein said computer contains instructions programming said computer to divide said unadjusted total intensify by a factor of less than 100.

20. An apparatus according to claim 17 wherein said computer contains instructions programming said computer to compute the raw intensity of each pixel within said configurable search area within a range of 0 to less than 1000.

21. An apparatus according to claim 17 wherein said computer contains instructions programming said computer to compute the raw intensity of each pixel within said configurable search area using all bits of the image.

22. An apparatus according to claim 17 wherein said computer contains instructions programming said computer to compute the raw intensity of each pixel within said configurable search area within a range of 0 to 255 for an 8 bit image.

23. An apparatus according to claim 18 wherein said computer contains instructions programming said computer to divide said unadjusted total intensify by a factor of less than 100.

24. An apparatus according to claim 18 wherein said computer contains instructions programming said computer to compute the raw intensity of each pixel within said configurable search area within a range of 0 to less than 1000.

25. An apparatus according to claim 18 wherein said computer contains instructions programming said computer to compute the raw intensity of each pixel within said configurable search area using all bits of the image.

26. An apparatus according to claim 18 wherein said computer contains instructions programming said computer to compute the raw intensity of each pixel within said configurable search area within a range of 0 to 255 for an 8 bit image.
